(19) United States
(12) Patent Application Publication
(10) Pub. No.: US 2022/0208168 A1
(43) Pub. Date: Jun. 30, 2022

(54) SOUND CANCELLATION USING MICROPHONE PROJECTION

(71) Applicant: Bose Corporation, Framingham, MA (US)

(72) Inventors: Yashar Motedayen Aval, Bedford, MA (US); Tyler White, Watertown, MA (US); Ben J. Feng, Sudbury, MA (US); Ankita D. Jain, Westborough, MA (US)

(73) Assignee: Bose Corporation, Framingham, MA (US)

(21) Appl. No.: 17/611,280

(22) PCT Filed: May 14, 2020
(86) PCT No.: PCT/US20/32778

§ 371 Date: Nov. 15, 2021

Related U.S. Application Data
(60) Provisional application No. 62/848,888, filed on May 16, 2019.

(51) Int. Cl. G10K 11/178; H04R 3/00

(52) U.S. Cl. CPC G10K 11/17854; G10K 11/17815; G10K 11/17825; H04R 2410/05; H04R 3/00; G10K 2210/30232; G10K 11/17883

(57) ABSTRACT

Audio systems, methods, and computer readable mediums having program code to receive a harmonic signal related to rotating equipment, such as a vehicle drivetrain in some examples, and provide a harmonic cancellation (or enhancement) signal. The harmonic cancellation signal is transduced into an acoustic signal, and a feedback sensor, such as a microphone, detects an error signal representative of acoustic energy at a first location in the environment. A projection filter filters the error signal to provide an estimated error signal at a second location in the environment, such as at the location of an occupant's ear(s). An adaptive module adjusts the cancellation signal based on the estimated error signal.

### CROSS REFERENCE TO RELATED APPLICATIONS

This application claims the benefit of U.S. Provisional Patent Application Ser. No. 62/848,888, titled “SOUND CANCELLATION USING MICROPHONE PROJECTION” filed May 16, 2019, which is incorporated herein in its entirety for all purposes.

### BACKGROUND

The present disclosure generally relates to systems and methods of minimizing an error signal representative of undesired sound at a location remote from a feedback sensor.

### SUMMARY

All examples and features mentioned below can be combined in any technically possible way.

Various aspects include a cancellation system, method, and/or program code, for the cancellation or reduction of undesired sounds, and in particular harmonics of rotating equipment, such as engine or other drivetrain harmonics and/or other equipment such as air conditioning equipment, fans, motor drives, etc. The system, method, or program code includes (or implements) a cancellation filter configured to generate a cancellation signal. The cancellation signal may be based on a reference signal received from a sensor, such as a tachometer or other sensor indicative of rotations, such as engine or drivetrain rotation (e.g., rotations per minute), that provides a signal representative of harmonic(s). A transducer disposed at a first location within an acoustic environment, such as a vehicle cabin, and configured to receive the cancellation signal and to transduce the cancellation signal into a cancellation audio signal within the environment. A feedback sensor, such as a microphone, may be disposed at a second location within the environment to output a feedback signal, which may be considered an error signal, the feedback signal being representative of sound at the second location. One or more projection filters may be configured to filter the feedback signal and/or the cancellation signal to provide an estimated error signal representing an estimate of the undesired harmonic sound at a third location remote from the first location and the second location. An adjustment module may be configured to adjust the cancellation filter, based on the estimated error signal, such that the cancellation audio signal destructively interferes with the undesired sound at the third location.

According to various examples, the sensor may indicate a rotational rate of an engine and may provide engine harmonic information. In some examples, the sensor may provide rotational information about other portions of a drivetrain, such as a transmission, transaxle, wheel, etc. In certain examples, the sensor may provide rotational information about other rotating equipment, such as drive motors, e.g., for actuating windows, wipers, etc., air conditioning equipment, fans, and the like. In some cases the sensor may further provide one or more substantially sinusoidal signals indicative of one or more harmonics of the rotating equipment.

In certain examples, the feedback sensor may be a microphone to detect acoustic energy within the environment, such as the cabin of a vehicle, and the location of the microphone may be a roof pillar, headliner, or other location. In various examples, the third location is an expected position of an occupant's ear(s). Accordingly, the feedback sensor signal may be a remote microphone signal and the estimated error signal may represent an estimate of the acoustic energy at the occupant's ear(s). Accordingly, the estimated error signal may be representative of a virtual microphone located at the third location, e.g., the roof microphone is ‘projected’ to the location of the occupant's ear(s).

In various examples, the estimated error signal is based on an estimate of an acoustic relationship between the second location (microphone) and the third location (occupant's ear). In certain examples, the estimated error signal may also be based on an estimate of an acoustic relationship between the first location (transducer) and the third location (occupant's ear), and an estimate of an acoustic relationship between the first location (transducer) and the second location (microphone).

In certain examples, the one or more projection filters comprises a first filter configured to estimate a relationship between the second location and the third location, the first filter being configured to receive and filter the feedback signal (the undesired sound at the second location) and to output a first filtered signal that is an estimate of the undesired sound at the third location. The first filter may be referred to as a projection filter, e.g., as it “projects” the feedback sensor (microphone) to an alternate location (occupant's ears) to yield an estimate of what the feedback signal would be if the feedback sensor were located at the alternate location.

In some examples, the one or more projection filters further comprises a second filter configured to estimate a relationship between the first location (transducer) and the third location (occupant's ears), the second filter being configured to receive and filter the cancellation signal and to output a second filtered signal that is an estimate of the cancellation audio signal at the third location, wherein the second filtered signal is configured to cancel a portion of the first filtered signal based on the cancellation audio signal received at the feedback sensor, when the first filtered signal and the second filtered signal are summed.

In certain examples, the one or more projection filters may be selected based upon certain vehicle operating conditions, as such may impact the acoustic relationship between the second location (e.g., microphone) and the third location (e.g., occupant's ear) and/or a transfer path between the first location (e.g., the transducer) and the third location (e.g., occupant's ear), also known as a secondary path transfer function. Accordingly, the certain vehicle and/or powertrain operating conditions upon which a filter selection is based may include one or more of the following: engine rotational rate (RPM), transmission RPM, engine output torque (τ), transmission output torque, throttle position, manifold vacuum, engine spark timing/rate, rate of change of engine and/or transmission RPM (e.g., delta-RPM, ΔRPM), loading/weighting and distribution of same, acceleration (transfers load to the rear suspension), braking/deceleration (transfers load to the front suspension), turning/cornering acceleration (transfers load from side-to-side), and/or suspension controls and/or damper stiffness (e.g., hydraulic, pneumatic, electronically controlled suspension components).

In certain examples, the one or more projection filters may be selected based upon certain conditions that may affect the cabin acoustics, as such may impact the relationship between the second and third locations and/or the transfer path between the first and third locations. Conditions upon which a filter selection is based may include one or more of the following: window position(s) (degree of open/close), sunroof position (degree of open/close), doors ajar (e.g., hatch opened or closed), seat positions (e.g., height, tilt, front/back), rear seat folded down or stowed, occupancy (number of occupants, which seats, weights, etc.) as may be detected by air-bag occupant sensors, cameras, etc.

In various examples, the one or more projection filters comprises at least one predictive filter such that the estimate of the undesired sound at the third location is an estimate of the undesired sound at the third location at a future point in time.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a schematic of an example sound cancellation system;

FIG. 2 is a schematic of another example sound cancellation system;

FIG. 3 is a schematic of an example tuning system;

FIG. 4 is a schematic of another example sound cancellation system;

FIG. 5 is a schematic of another example sound cancellation system;

FIG. 6 is a schematic of another example sound cancellation system; and

FIG. 7 is a schematic of another example sound cancellation system.

### DETAILED DESCRIPTION

Sound cancellation systems that cancel or reduce undesired sounds in a predefined volume, such as harmonic cancellation in a vehicle cabin, often employ a feedback sensor (such as a microphone) to generate an error signal (or feedback signal) representative of residual uncancelled sounds. This error signal is fed back to an adaptive filter that adjusts a cancellation signal in an attempt to minimize the residual uncancelled sound.

However, in some contexts, the feedback sensor may not be positioned at an optimal location. For example, in the vehicle context, the feedback sensor may be placed in the roof, pillar, or headrest, but the undesired sound should be canceled at a passenger's ears. As a result, the error signal is indicative of the error at the feedback sensor, but not at the passenger's ears. This is undesirable because the objective of the cancellation system is to cancel undesired sounds at the passenger's ears. Placing microphones on passenger's ears, however, is impractical and likely unacceptable to the passenger. In some examples, however, a priori measurements by a microphone placed at an ear location may determine an acoustic relationship between the ear location and the feedback sensor location. Accordingly, the feedback sensor signal (e.g., a roof mic) may be ‘projected’ to an equivalent ear mic signal. Alternatively stated, a roof mic signal may be filtered (based upon the acoustic relationship between the two locations) to provide a virtual ear mic signal. In various examples, the acoustic relationship between the feedback sensor location and the passenger ear location may vary depending upon vehicle and cabin conditions as described herein, such that the filter may be selected based upon such vehicle and/or cabin conditions.

In addition, sound cancelling audio signals—in the vehicle and other contexts—are typically delayed approximately five milliseconds, as the audio signal must travel from a speaker disposed along the perimeter of the vehicle cabin to the passenger's ears (e.g., the cancelling audio signal must travel from approximately five feet away from the passenger's ear, and the speed of sound is approximately one foot per millisecond). This delay prevents optimal cancelling because the cancelling audio signal, as perceived by the passenger is directed toward sound that has already occurred. Accordingly, some examples may include features to predict future values of the residual sound at the occupant's ear without placing a microphone at the occupant's ear. Further details of predicting sound or residual sound may be found in U.S. Pat. No. 10,629,183 issued on Apr. 21, 2020, titled SYSTEMS AND METHODS FOR NOISE-CANCELLATION USING MICROPHONE PROJECTION, which is incorporated herein in its entirety for all purposes.

Various examples disclosed herein are directed to a cancellation system that estimates an error signal representative of residual uncancelled sound at a location remote from the feedback sensor. The estimation, in an example, is based on available information from, namely, remote reference microphones, and from knowledge of the relationship between those remote microphones and the sound field at the passenger's ears and of the output of the sound cancellation system itself.

The resulting adjustment to the adaptive filter, based on the estimated error signal, will minimize the estimated error signal and thus cancel the undesired sound at the remote location rather than at the feedback sensor, e.g., effectively projecting the feedback sensor to the remote location. This may alternately be understood as shifting the cancellation zone from the feedback sensor to the location remote from the feedback sensor.

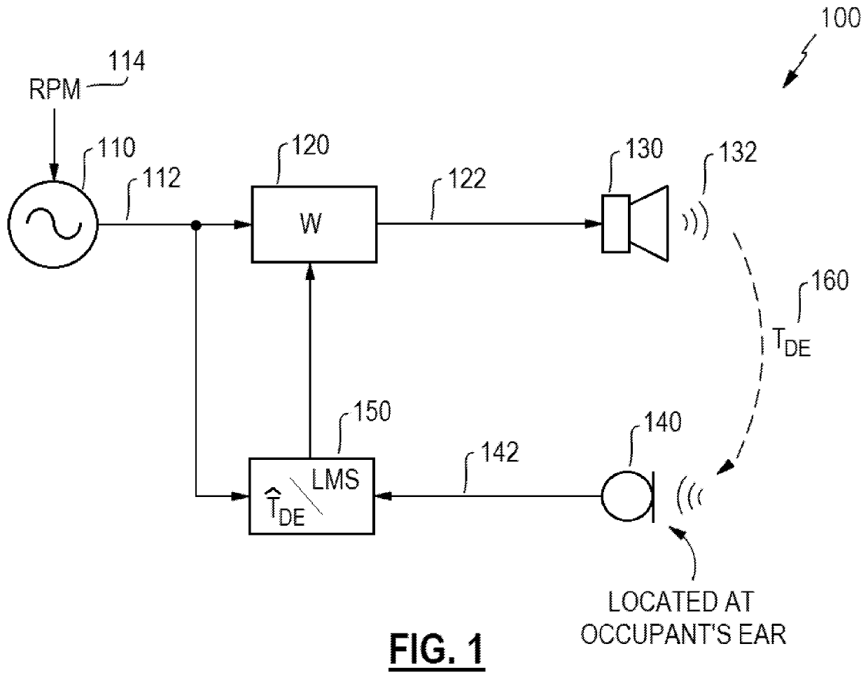

FIG. 1 is a schematic diagram and/or signal flow diagram of an example sound cancellation system 100 that includes a signal source 110, a cancellation filter 120, a transducer 130 (e.g., loudspeaker or driver), a microphone 140 (feedback sensor), and an adaptation module 150. In various examples, the signal source 110 may be a signal generator that provides a reference signal 112 that may include components representative of harmonics of rotating equipment associated with the environment. For example, in a vehicle the drivetrain, e.g., engine, transmission, transaxle, wheels, etc., may generate various harmonics that produce audible sound in the vehicle. The noise cancellation system 100 may be configured to reduce the audible harmonics. The signal source 110 may therefore generate the reference signal 112 representative of the harmonics of the rotating equipment. Accordingly, in some examples the signal source 110 may receive rotational information, such as a rotating rate, which may be in rotations per minute (RPM), from a sensor 114. In some examples, the reference signal 112 may include a number of sinusoidal signals at various frequencies representing one or more harmonics of the rotating equipment.

The cancellation filter 120 receives the reference signal 112 and filters the reference signal 112 to produce a cancellation signal 122. The cancellation signal 122 is a driver signal that drives the transducer 130 to produce a cancellation audio signal 132 in the environment, e.g., in the cabin of a vehicle in some examples. The microphone 140 is a feedback sensor that detects sound in the environment and provides an error signal 142. The adaptation module 150 receives the reference signal 112 and the error signal 142 and updates the cancellation filter 120 to minimize the error signal 142. Accordingly, the adaptation module 150 adjusts the cancellation filter 120 such that harmonic sounds at the microphone 140 are reduced.

In the example sound cancellation system 100 of FIG. 1, if the microphone 140 is ideally located at an occupant's ear, the system will effectively reduce or remove the sound of harmonics at the occupant's ear. The cancellation audio signal 132 reaches the microphone 140 via a transfer function 160, T_{DE}, which is a transfer function from the driver (location of the transducer 130) to the ear (location of the microphone 140). In various examples, the adaptation module 150 may be programmed with an estimate of the transfer function 160 and may implement an adaptive algorithm, such as any of various least mean squares (LMS) or alternate algorithms, to adjust a transfer function, W, of the cancellation filter 120 to minimize the error signal 142.

While the example sound cancellation system 100 of FIG. 1 contemplates the microphone 140 located at or very near an occupant's ear, it may generally be unacceptable or impractical to place a microphone near an occupant's ear. In various examples, such a feedback microphone may instead be located nearby but remote from an occupant's ear, such as a roof, headliner, headrest, pillar, or elsewhere.

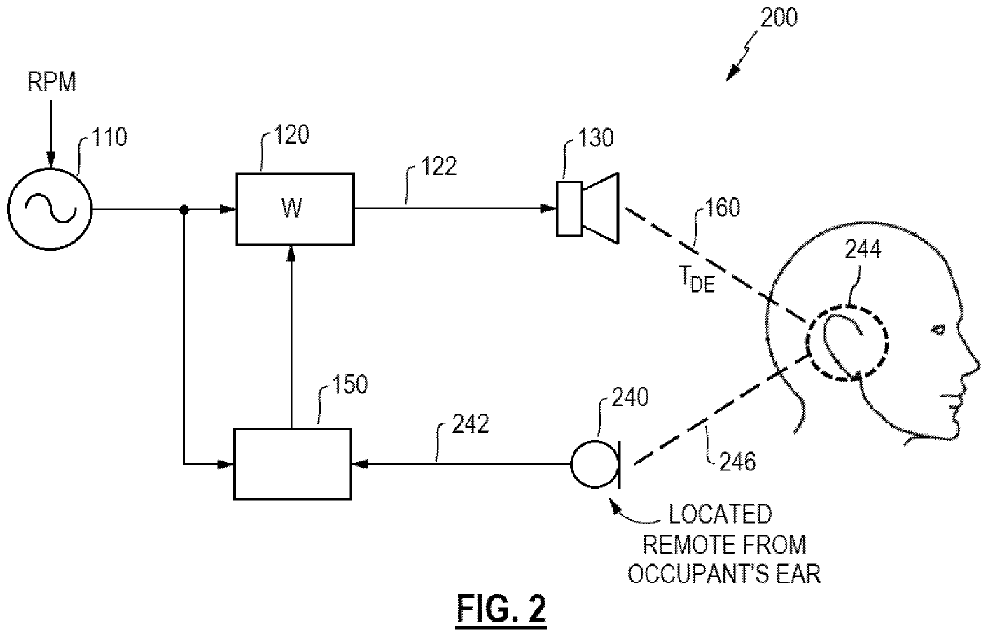

FIG. 2 illustrate another example sound cancellation system 200 that is similar to the sound cancellation system 100 except that the feedback sensor, microphone 240, is located remote from an occupant's ear 244. Accordingly, an error signal 242 from the microphone 240 may not represent the undesired sound at the location of the occupant's ear 244. The sound cancellation system 200 of FIG. 2 operates in the same or similar manner to the sound cancellation system 100 of FIG. 1 and thereby may reduce the sound of harmonics at the location of the microphone 240, but not necessarily at the occupant's ear 244. Accordingly, the sound cancellation system 200 is not optimized to reduce harmonic sounds at the occupant's ear 244.

However, sound at the location of the microphone 240 has a relationship 246 to sound at the location of the occupant's ear 244. The relationship 246 depends upon the source of sound and the manner in which the audible vibrations are transferred from the source and through the acoustics of the environment. For example, a particular harmonic, when operating at a particular frequency, may create a particular relationship 246, e.g., in terms of amplitude and phase, between the sound of the harmonic at the occupant's ear 244 and at the microphone 240. In various examples, a different harmonic may create a different relationship 246, even when operating at the same frequency (e.g., a first harmonic may create a certain frequency at a given RPM as a second harmonic does at a lower RPM) (e.g., a 100 Hz acoustic signal may be a first harmonic at one RPM and may be a second harmonic at another RPM). Further, in various examples, the relationship 246 may change with any of various operating conditions, such as torque, acceleration, vehicle loading, etc., as well as with acoustic properties of the environment, such as seat positions, window conditions, vehicle occupancy, loading aging, etc.

In various examples, the relationship 246 is measured a priori for any number of harmonics of interest (to accommodate differing system goals) and under various conditions, and a projection filter is generated to filter the error signal 242 to effectively account for or reverse the effect of the relationship 246 such that the filtered signal represents an estimate of the error signal at the occupant's ear 244. According to various examples, the relationship 246 is measured for each harmonic across a range of rotational rates and thus a range of corresponding frequencies. The relationship 246 may then be equivalently modeled as a transfer function as a function of frequency, e.g., a set of phase and amplitude relationships across a range of frequencies for a given harmonic. Accordingly, in various examples, the projection filter transfer function effectively projects the microphone 240 to the location of the occupant's ear 244, and may be referred to herein as W_{RE}, because it relates the remote location (e.g., roof location in some examples) to the ear location.

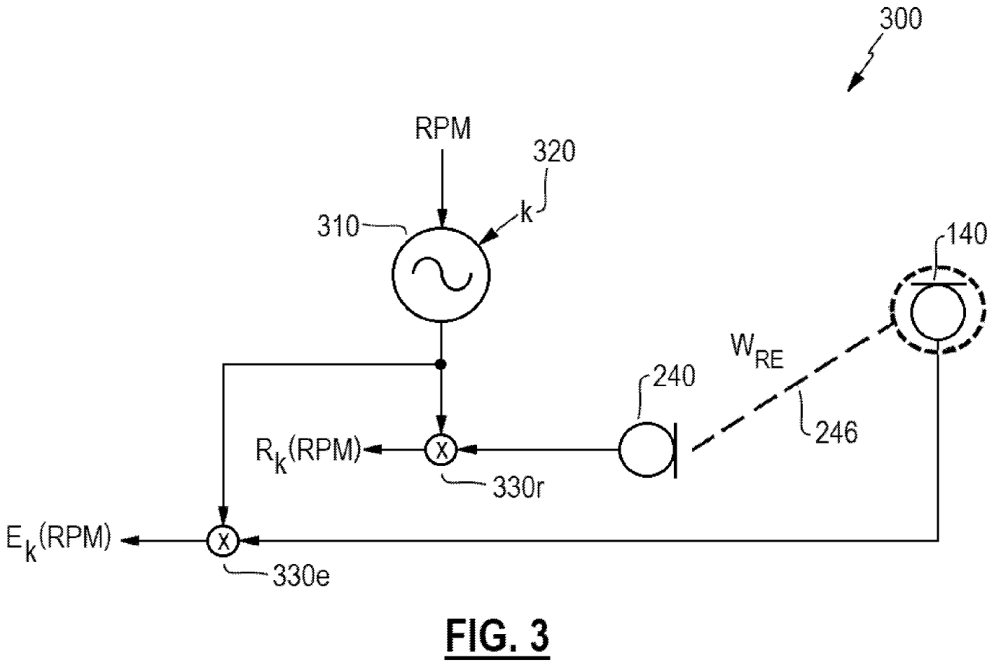

FIG. 3 illustrates an example tuning system 300 that may be used in some examples to measure one or more relationships 246, under various conditions, between sounds at an ear location and at a remote location. The microphone 140 is positioned to be at an ear location and the microphone 240 is positioned at the remote location, e.g., where it will be located in operation, such as a roof; headliner, pillar, etc. A sinusoidal source 310 provides a selected harmonic 320, k, (e.g., k=1, 2, 3, . . . , n) based upon the rotational rate (e.g., RPM) of the equipment for which it is desired to alter/cancel the sounds, such as in accord with expression in (1):

e^{-jωt×RPM×k/60} (1)

where k is the harmonic number and the rotational rate (RPM) is expressed in rotations per minute. Mixers 330 mix the sinusoidal signal with the respective signals from the microphones 140, 240 to provide an ear phasor, Eₖ, and a remote phasor, Rₖ, respectively.

For clarity, each phasor includes amplitude and phase information. While the phase of the audio source (the rotating equipment) may be ambiguous, the phasors Eₖ and Rₖ are expected to have substantially constant relative phases, e.g., the phase of one relative to the other is fixed, and likewise with their relative amplitudes, and such characterizes the relationship 246 for the given harmonic, k, at a given RPM. Multiple such measurements are made at each of numerous rotational rates. The frequency of the harmonic, k, changes with rotational rate and therefore the relationship 246 may be characterized as a set of amplitude and phase relationships across a range of frequencies, for a given harmonic, k.

Accordingly, the relationship 246 may be equivalently considered as a transfer function between the two positions, e.g., the ear location (e.g., microphone 140) and the remote location (e.g., microphone 240), a transfer function being a phase and magnitude relationship across a range of frequencies, such as from an “input” to an “output.” Accordingly, a filter having a related transfer function may account for the remote location of the microphone 240, e.g., such that the filter “projects” the microphone's signal to the ear location, e.g., as if the microphone 240 were located at the ear.

In some examples, such a transfer function may be conceived as an actual transfer function for acoustic energy that arrives at a first of the locations and as it progresses to the second location. Such may hold true for audio coming from a given source and under specific operating conditions. For example, a 100 Hz first harmonic (k=1) coming from the engine may create a specific relationship 246, but a 100 Hz second harmonic (k=2) may create a different relationship. Likewise, a 100 Hz tone coming from a loudspeaker in the vehicle will likely create a much different relationship, as the source location of the tone and its transmission to the two locations will be vastly different from the 100 Hz first engine harmonic.

In various examples, multiple measurements may be made for each harmonic, k, and at each rotational rate, and an average phase and amplitude relationship may be used for a given harmonic and rotational rate. Additionally, and as presented in greater detail below, a relationship 246 for a given harmonic and rotational rate may depend upon further parameters, such as torque, loading, window positions, etc. In various examples, multiple measurements at varying torques (or other variations in operational parameters) may be made and an average phase and amplitude relationship may be used for a given harmonic and rotational rate under an “average” torque operating condition.

For instance, in some examples, a number of measurements may be made across a range of positive torque conditions and an average of these is used when the vehicle is operated with positive torque. Likewise, in some examples, a number of measurements may be made across a range of negative torque conditions and an average of these is used when the vehicle is operated with negative torque. Additionally, some examples may include a number of measurements made across a number of substantially neutral torque conditions and an average of these is used when the vehicle is operated with substantially neutral torque.

As described above, FIG. 3 is an example tuning system 300, which is a temporary configuration to make measurements to characterize the relationship 246 of various harmonics at various rotational rates. Various examples of sound cancellation systems in accord with those described herein will not include a microphone 140 located at an occupant's ear. Various sound cancellation systems herein include one or more projection filters to each apply a transfer function to a remote microphone signal (e.g., from the microphone 240) with the purpose of estimating a signal that an ear microphone (e.g., microphone 140) would produce if it were present.

Some examples may include multiple remote microphones 240, such as for multiple locations in the vehicle. Further, some examples of a tuning system similar to that of FIG. 3 may include multiple remote microphones 240 and also may include multiple ear microphones 140, such as for each side of an occupant's head and/or for multiple occupants. Accordingly, Rₖ and Eₖ may each be a column vector whose number of elements are the number of remote microphones and the number of ear microphones, respectively. In such examples, a transfer function of a projection filter (a filter that receives remote microphone signals and estimates ear microphone signals) may be a matrix. In other examples, such a transfer function may be considered to be a plurality of projection filters, each “projecting” a remote microphone location to an ear microphone location.

Many of the quantities discussed herein are related to a rotational rate, and each harmonic has a particular frequency at a given rotational rate. Accordingly, for a given harmonic, various quantities described will be dependent on rotational rate and, therefore, frequency. For simplicity, further discussion below omit annotation of frequency and/or rotational rate, e.g., “x(f)” and/or “x(RPM).” Further, the harmonic subscript, k. may also be excluded in various cases, but it should be understood by those of skill in the art that each relationship and/or projection filter transfer function is across a range of frequencies and for a particular harmonic.

Having measured a number of relationships 246 for particular harmonics across various rotational rates, the job of a projection filter as described herein is to “project” or transform a remote microphone signal (R) to an estimated ear microphone signal (Ê), via a projection filter transfer function, W_{RE}, as in the relationship in Eq. 2:

Êₖ=W_{RE}×Rₖ (2)

The projection filter transfer function, W_{RE}, may be devised in various ways given the measurement data of Eₖ and Rₖ from a tuning system similar to that in FIG. 3. In at least one example, the projection filter transfer function, W_{RE}, may be determined in accord with Eq. 3:

W_{RE}=E̅ₖ̅R̅ₖ̅^̅{̅H̅}̅×{R̅ₖ̅R̅ₖ̅^̅{̅H̅}̅}⁻¹ (3)

where ‘H’ is a Hermitian operator and bars over a quantity represent an expected or average value over a number of measurements. The above expression represents at least one form of a projection filter transfer function in at least one example based upon minimizing an error between the estimated Eₖ and the actual Eₖ. Other forms of projection filter transfer functions may be derived from minimizing other quantities or parameters in various examples.

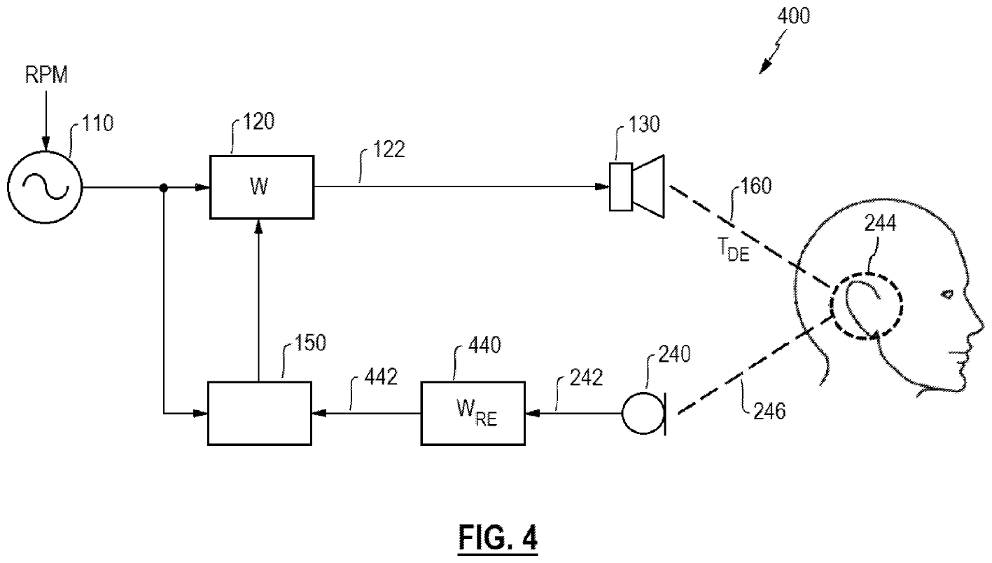

According to various examples, the projection filter transfer function, W_{RE}, is applied in accord with an example sound cancellation system 400 as illustrated in FIG. 4. The sound cancellation system 400 includes a projection filter 440 that receives the error signal 242 from the microphone 240 and filters it to generate an estimated error signal 442. The estimated error signal 442 is thereby an estimate of an error signal that would have been provided by an ear microphone, e.g., it is an estimate of the error signal 142 that the microphone 140 would have provided, with reference to FIG. 1 wherein the microphone 140 is an ear microphone. As described above, various examples may include multiple microphones 240 and may estimate multiple ear microphones, and thus the projection filter 440 may be a multi-input and/or a multi-output filter, e.g., W_{RE} may be a matrix or a vector.

With continued reference to FIG. 4, and as described above, the driver 130 produces a cancellation audio signal 132 that is also picked up by the microphone 240. As further described above, the transform W_{RE} is specific to a particular noise source, e.g., the engine, and a particular harmonic from the noise source. Accordingly, the projection filter transfer function, W_{RE}, is incorrect for the cancellation audio signal 132, e.g., it does not accurately estimate the cancellation audio signal 132 at the occupant's ear location. Accordingly, any component of the error signal 242 that came from the cancellation audio signal 132 at the microphone 240 is, essentially, a corrupting signal. Accordingly, various examples may include one or more additional filters to correct for such components.

As described above, the cancellation signal 122 is a driver signal, D, that drives the transducer 130 to produce the cancellation audio signal 132. Accordingly, content in the error signal 242 that is a result of the cancellation audio signal 132 may be described by the expression in (4):

W_{RE}×T_{DR}×D (4)

where D is the driver signal (e.g., the cancellation signal 122) and T_{DR} is a transfer function from the driver signal to the location of the remote microphone 240. In various examples T_{DR} may be a measured transfer function and/or an estimate.

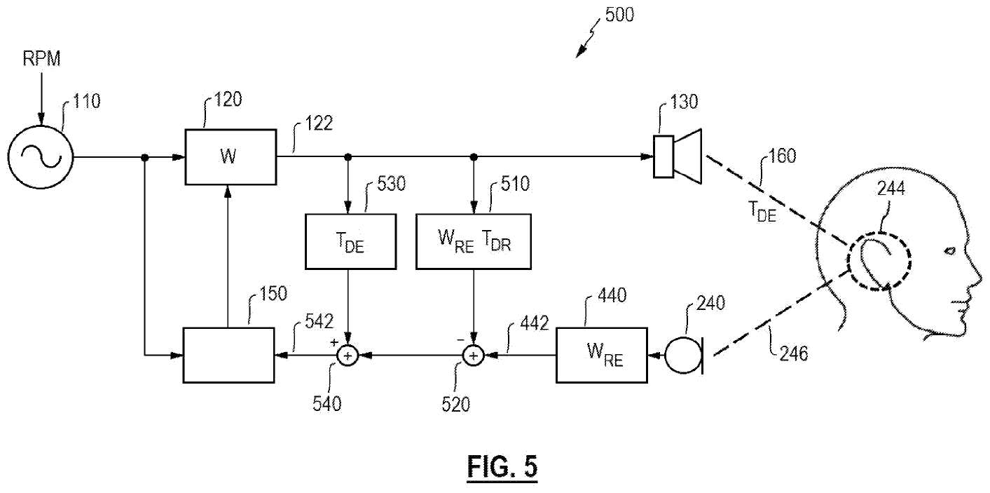

FIG. 5 illustrates another example sound cancellation system 500 that is similar to the sound cancellation system 400 that includes additional filters to compensate for ‘corruption’ in the estimated error signal 442 caused by the cancellation audio signal 132 being processed by the projection filter 440. In simplified terms, the sound cancellation system 500 subtracts the ‘corrupt’ component(s) as described above in (4) from the estimated error signal 442 to produce a signal that represents an estimate of the undesired signal at the occupant's ear without the effects of the cancellation audio signal 132. The sound cancellation system 500 also adds back in the effect of the cancellation audio signal 132 at the occupant's ear, to produce a signal that is an estimate of the residual undesired signal at the occupant's ear, which is an estimated error signal that the adaptation module 150 may use to update the cancellation filter 120.

With particular reference to FIG. 5, the sound cancellation system 500 includes a first correction filter 510 that receives the driver signal 122 and outputs an estimate of the ‘corrupt’ portion of the estimated error signal 442 (e.g., see (4) above), which is then subtracted from the estimated error signal 442 by a combiner 520. The sound cancellation system 500 also includes a second correction filter 530 that receives the driver signal 122 and outputs an estimate of the actual contribution of the cancellation audio signal 132 at the occupant's ear, which is then added by a combiner 540, to produce a corrected estimated error signal 542. In various examples, the second correction filter 530 applies a transfer function, T_{DE}, that, as described above, is a secondary path transfer function from the driver to the location of the occupant's ears (or an estimate thereof).

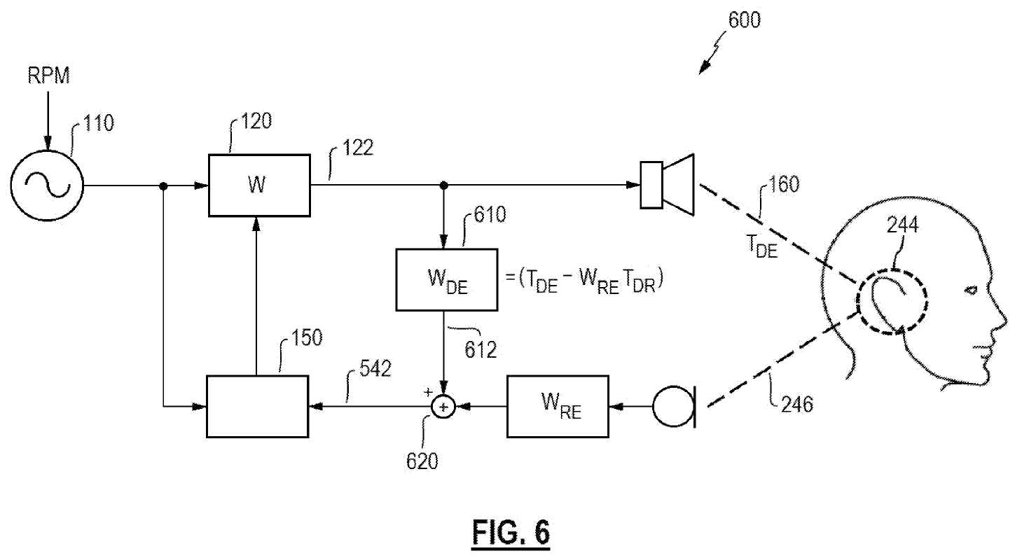

FIG. 6 illustrates an example sound cancellation system 600 that is a simplification of the sound cancellation system 500 of FIG. 5. The sound cancellation system 600 combines the first and second correction filters 510, 530 with a single correction filter 610 that receives the driver signal 122 and outputs a combined correction signal 612 and adds it to the estimated error signal 442 via a combiner 620 to produce the corrected estimated error signal 542.

In various examples, the transfer function of the correction filter 610 may be insignificant, such as when the ‘corrupt’ component(s) as described in (4) above are substantially equivalent to the actual contribution of the cancellation audio signal 132 at the occupant's ear. In such cases, the correction filter 610 may be omitted and the system may be simplified back to substantially that shown in FIG. 4.

As described above, any of various relationships 246 for a certain harmonic may vary based upon any of one or more of the following: engine rotational rate (RPM), transmission RPM, engine output torque (τ), transmission output torque, throttle position, manifold vacuum, engine spark timing/rate, rate of change of engine and/or transmission RPM (e.g., delta-RPM, ΔRPM), loading/weighting and distribution of same, acceleration (transfers load to the rear suspension), braking/deceleration (transfers load to the front suspension), turning/cornering acceleration (transfers load from side-to-side), and/or suspension controls and/or damper stiffness (e.g., hydraulic, pneumatic, electronically controlled suspension components).

Accordingly, in various examples, a different transfer function, W_{RE}, for the projection filter and/or a different transfer function, W_{DE}, for the correction filter may be selected on the basis of variation of any of the above operational parameters of the vehicle. For simplicity, in the description below an example is presented with respect to selecting differing transfer functions based upon torque, τ, but it is understood that any of the above or other operational parameters may serve as a basis for selecting, changing, retrieving, or storing a transfer function for any of a projection filter and/or a correction filter.

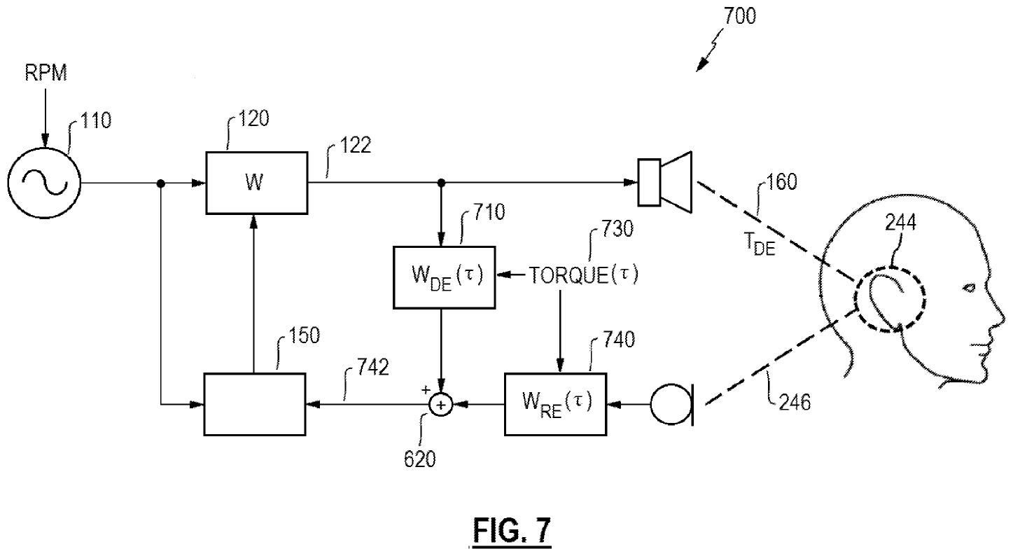

FIG. 7 illustrates another example sound cancellation system 700 that adjusts the transfer function of one or more of a projection filter 740 and/or a correction filter 710 based upon an indication of torque, τ, e.g., from a torque sensor 730, to produce a (corrected) estimated error signal 742.

In various examples, filter transfer functions for a specific torque may be determined by making measurements (e.g., via tuning system 300) over multiple runs recorded at that specific torque, and/or the projection filter transfer function, W_{RE}, for a specific torque may be estimated by evaluating expected values for recordings made at that specific torque. In various examples, a reduced number of filter transfer functions, W_{RE}, W_{DE}, may be used (e.g., to reduce storage requirements) by measuring or determining one each for positive torque and negative torque. For example, the mechanics of transmission of harmonic sounds into the cabin may vary significantly when the drivetrain is under positive output torque versus negative output torque. In various examples, multiple levels of positive torque, negative torque, and in some cases neutral torque (e.g., coasting) may each have a determined projection. Accordingly, various examples may store a number of filter transfer functions W_{RE}, W_{DE}, each of which is available to be selected and applied based upon a current vehicle operating condition, such as torque, but in various examples including any number of additional operating conditions, as described variously above. In some examples, a system or method may interpolate for an operating condition between those for which recordings and filter transfer functions were determined. For instance, in at least one example, a system may have stored filter transfer functions W_{RE}, W_{DE}, associated with torque values −50 Newton-meters (N-m), 0 N-m, and 200 N-m, and at a time when the current torque is 100 N-m, filter transfer functions may be interpolated, e.g., between the stored transfer functions for 0 N-m and 200 N-m.

In addition to the vehicle powertrain operation and loading as described above, the relationship 246 for various harmonics and the transfer function 160 (secondary path) from transducer 130 to the occupant's ear 244 may vary as environmental (e.g., cabin) acoustics change. Therefore, various examples of sound cancellation systems or algorithms herein may dynamically change (adjust, select) the projection filter transfer function and/or the correction filter transfer function based on changes in cabin acoustics.

In various examples, changes in cabin acoustics may be communicated via digital control signals, and for example may include window conditions open/closed (which and how much), sunroof condition open/closed (and how much), hatch door condition open/closed, rear seat condition (folded down, stowed, etc.), cargo/carrying load, and occupancy such as how many occupants are present in the cabin, in which seats, and how large are they, as well as others. For example, occupancy may be estimated by data from air-bag occupant sensors in the seats. In some examples, cameras, video, and/or facial recognition systems may also provide information about cabin conditions.

While examples herein have been described in regards to cancellation or reduction of harmonics of rotating equipment, the example systems, methods, and program code may be beneficially applied to enhancement or other modification of harmonic acoustic signals. In such examples, the cancellation filter as described herein may be an enhancement filter configured and adapted to provide an enhancement signal that causes the transducer to provide an enhancement audio signal to modify the sound of one or more harmonics at the occupant's ear. The feedback sensor (remote microphone) may be “projected” to the occupant's ear location in similar manner to those example systems and methods described above. Accordingly, in such examples, one or more of a projection filter and/or a correction filter may be applied in similar manner to the examples described herein to provide an estimated signal representative of the sound at the occupant's ear and may adapt the enhancement filter (the otherwise cancellation filter) to achieve a target sound of the one or more harmonics.

In various examples, harmonic enhancement, reduction, or cancellation may be performed for multiple occupant locations. For example, remote microphones 240 may be included to detect acoustic energy at more than one location and multiple projection and correction filters may be stored for multiple occupant ear locations. In such examples, harmonic enhancement, reduction, or cancellation may be performed for selected occupant locations dependent upon actual occupancy and/or user selection. For instance, a rear seat occupant may be detected and example systems herein may operate to reduce harmonics at the ears of the rear occupant while also reducing harmonics at an operator's ears (e.g., in the driver's seat). However, the system may de-activate harmonic reduction at the rear occupant's ear location when it is detected that there is no rear occupant and/or based upon user selection to disable harmonic reduction in the rear seat location. De-activation of harmonic reduction at one or more locations may enable better performance of harmonic reduction at other locations, as such a system may minimize acoustic harmonic content at fewer locations.

While examples herein have been described with respect to a vehicular environment, the example systems, methods, and program code may be beneficially applied to cancellation, enhancement, or other modification of harmonic acoustic signals in other environments, such as industrial, manufacturing, factory, electric production, or other environments that may involve rotating equipment that may produce undesired acoustic harmonic noise.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

While several inventive examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, through routine experimentation, many equivalents to the specific inventive examples described herein. It is therefore to be understood that the foregoing examples are presented by way of example only and that, within the scope of the appended claims and equivalents thereto, inventive examples may be practiced otherwise than as specifically described and claimed. Inventive examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. A sound cancellation system, comprising:
a transducer configured to receive a cancellation signal and produce a cancellation audio signal in a vehicle;
a microphone configured to provide an error signal representative of acoustic energy at a first location in the vehicle; and
a projection filter configured to filter the error signal to provide an estimated error signal at a second location in the vehicle, the projection filter selected based upon a condition of the vehicle; and
an adaptive module that adjusts the cancellation signal based on the estimated error signal.

2. The sound cancellation system of claim 1 wherein the condition of the vehicle is one of a powertrain operating condition or a cabin acoustic condition.

3. The sound cancellation system of claim 1 wherein the condition of the vehicle is one or more of a rotational rate, a rate of change of rotational rate, a torque, a load, a manifold vacuum, and a rate of acceleration.

4. The sound cancellation system of claim 1 further comprising a correction filter configured to filter the cancellation signal to provide a correction signal that is combined with the estimated error signal to provide a corrected estimated error signal, the sound cancellation system configured to adjust the cancellation signal based on the corrected estimated error signal.

5. The sound cancellation system of claim 4 wherein the correction filter is selected based upon the condition of the vehicle.

6. The sound cancellation system of claim 1 further comprising a cancellation filter that receives a harmonic signal and provides the cancellation signal, the sound cancellation system configured to adjust the cancellation signal by adjusting the cancellation filter.

7. A sound cancellation system, comprising:
a cancellation filter that receives a harmonic signal related to a rotating equipment and provides a cancellation signal;
a transducer coupled to the cancellation filter that receives the cancellation signal and produces a cancellation audio signal in an environment;
a microphone configured to provide an error signal representative of acoustic energy at a first location in the environment;
a projection filter configured to filter the error signal to provide an estimated error signal at a second location in the environment; and
an adaptive module that adjusts the cancellation signal based on the estimated error signal.

8. The sound cancellation system of claim 7 wherein the projection filter is selected based upon an operating condition of the rotating equipment or an acoustic condition of the environment.

9. The sound cancellation system of claim 8 wherein the operating condition is one or more of a rotational rate, a rate of change of rotational rate, a torque, a load, a manifold vacuum, and a rate of acceleration.

10. The sound cancellation system of claim 7 further comprising a correction filter configured to filter the cancellation signal to provide a correction signal that is combined with the estimated error signal to provide a corrected estimated error signal, the adaptive module configured to adjust the cancellation signal based on the corrected estimated error signal.

11. The sound cancellation system of claim 10 wherein the correction filter is selected based upon an operating condition of the rotating equipment or an acoustic condition of the environment.

12. A method of cancelling sound, comprising:
transducing a cancellation signal into a cancellation audio signal in a cabin of a vehicle;
detecting an error signal at a first location in the cabin by a feedback sensor, the error signal representing acoustic energy at the first location;
filtering the error signal to provide an estimated error signal at a second location in the cabin, via a projection filter selected based upon a condition of the vehicle; and
adjusting the cancellation signal based on the estimated error signal.

13. The method of claim 12 wherein the condition of the vehicle is one of a powertrain operating condition or an acoustic condition of the cabin.

14. The method of claim 12 wherein the condition of the vehicle is one or more of a rotational rate, a rate of change of rotational rate, a torque, a load, a manifold vacuum, and a rate of acceleration.

15. The method of claim 12 further comprising filtering the cancellation signal to provide a correction signal, via a correction filter, combining the correction signal with the estimated error signal to provide a corrected estimated error signal, and adjusting the cancellation signal based on the corrected estimated error signal.

16. The method of claim 15 wherein the correction filter is selected based upon the condition of the vehicle.

17. The method of claim 12 further comprising filtering a harmonic signal to provide the cancellation signal, via a cancellation filter, and adjusting the cancellation signal by adjusting the cancellation filter.

18. A method of adjusting harmonic sound, comprising:
filtering a harmonic signal related to a rotating equipment to provide a cancellation signal;
transducing the cancellation signal into a cancellation audio signal in an environment;
receiving an error signal representative of acoustic energy at a first location in the environment;
filtering the error signal to provide an estimated error signal at a second location in the environment; and
adjusting the cancellation signal based on the estimated error signal.

19. The method of claim 18 wherein filtering the error signal to provide an estimated error signal is based upon an operating condition of the rotating equipment or an acoustic condition of the environment.

20. The method of claim 19 wherein the operating condition is one or more of a rotational rate, a rate of change of rotational rate, a torque, a load, a manifold vacuum, and a rate of acceleration.

21. The method of claim 18 further comprising filtering the cancellation signal to provide a correction signal, combining the correction signal with the estimated error signal to provide a corrected estimated error signal, the adjusting the cancellation signal based on the corrected estimated error signal.

22. The method of claim 21 wherein filtering the cancellation signal to provide a correction signal is based upon an operating condition of the rotating equipment or an acoustic condition of the environment.

23. A non-transitive computer readable medium having instructions recorded thereon that, when executed by one or more processors, cause the one or more processors to perform a method comprising:
providing a cancellation signal to be transduced into an acoustic signal in an environment;
receiving an error signal from a feedback sensor at a first location in the environment, the error signal representative of acoustic energy at the first location;
filtering the error signal, by a projection filter, to provide an estimated error signal at a second location in the environment, a transfer function of the projection filter selected based upon an operating condition of a rotating equipment; and
adjusting the cancellation signal based on the estimated error signal.

24. The computer readable medium of claim 23 wherein the operating condition is one of a vehicle powertrain operating condition or a vehicle cabin acoustic condition.

25. The computer readable medium of claim 23 wherein the operating condition is one or more of a rotational rate, a rate of change of rotational rate, a torque, a load, a manifold vacuum, and a rate of acceleration.

26. The computer readable medium of claim 23 further comprising filtering the cancellation signal to provide a correction signal, via a correction filter, combining the correction signal with the estimated error signal to provide a corrected estimated error signal, and adjusting the cancellation signal based on the corrected estimated error signal.

27. The computer readable medium of claim 26 wherein the correction filter is selected based upon the operating condition.

28. The computer readable medium of claim 23 further comprising filtering a harmonic signal related to the rotating equipment to provide the cancellation signal.
